(19) United States
(12) Patent Application Publication
(10) Pub. No.: US 2021/0279989 A1
(43) Pub. Date: Sep. 9, 2021

(54) IDENTITY DOCUMENT VERIFICATION

(71) Applicant: SITA Information Networking Computing UK Limited, Middlesex (GB)

(72) Inventor: Kevin O'SULLIVAN, Hampshire (GB)

(21) Appl. No.: 17/259,062

(22) PCT Filed: Apr. 8, 2019
(86) PCT No.: PCT/EP2019/058840

§ 371 Date: Jan. 8, 2021

(30) Foreign Application Priority Data
Jul. 16, 2018 (GB) 1811642.6

(51) Int. Cl. G07C 9/25; G07C 9/27; H04L 9/32; G06K 9/00; G06N 20/00

(52) U.S. Cl. CPC G07C 9/257; G07C 9/27; H04L 9/3231; H04L 2209/38; H04L 9/3247; G06K 9/00483; G06N 20/00; H04L 9/3239

(57) ABSTRACT

A method and system for identity document verification issues a decentralised identifier for a passenger which is then used by a passport issuing authority to digitally sign passport data including enhanced biometric data including an image of the bearer. A copy of the signed data is provided to the bearer. Prior to travel the bearer submits APIS data and their decentralised identifier to the authorities at the arrival destination. This data is verified in advance and the bearer issued with authority to use a pre-authorised section at immigration. On arrival an image of the bearer is acquired and matched with records of pre-approved traveler. If a match is made, the bearer is permitted to pass through automatic border control gates. The matching process may use machine learning to reduce the set of pre-approved passengers used in the match based on predicted time of arrival at immigration.

### FIELD OF THE INVENTION

This invention relates to identity document verification and in particular to verification of identity documents such as passports by immigration authorities at airports, sea ports and other border crossings.

### BACKGROUND TO THE INVENTION

In the air transport industry a long standing problem exists of how to handle passengers through immigration when passengers are travelling from one country to another. Traditionally passengers are required to show a passport or other identity document to an immigration official for checking before being allowed into a country. This process is time consuming and requires considerable resources, both in terms of equipment and manpower to be provided by the government of the country at which the passengers arrive. In times of heightened security passport checks take longer to perform and at peak times, such as during the summer holiday season, passenger volumes rise greatly. These two factors place a great demand on immigration systems and can result in long queues of passengers leading to passenger dissatisfaction.

More recently, some governments have introduced biometric passports, sometimes referred to as e-passports in which the passport holder's details are stored electronically in a form that can be machine read. The details stored are the data that is printed on the passport's data page: the holder's name, date of birth, a digital representation of the holder's photograph that appears on the passport, other biographic information and a biometric identifier.

Biometric passports have the advantage that they enable use of automated border controls (ABCs) which use electronic gates and facial recognition software, A passenger presents their passport for scanning and the gate then scans their face and performs a match against the digital image of the passport stored on the passport. If the images match, and the other personal data is verified, the gate opens and the passenger can proceed.

Although biometric passports have enabled a reduction in queuing times at airport immigration, and a reduction in staffing numbers, they are still relatively slow and require a considerable capital outlay. The industry has identified a general need to improve the immigration process while retaining high levels of security.

Amongst the initiatives being considered are those that provide a digital identity token for passengers. One known example is Self-Sovereign Identity (SSI) which is descried in the following references: https://bitsoblocks.net/2017/05/17/a-gentle-introduction-to-self-sovereign-identity/https://sovrin.org/wp-content/uploads/2017/06/The-Inevitable-Rise-of-Self-Soverign-identity.pdf

Self-Sovereign Identity relies on three basic concepts: claims, proofs and attestation. A claim is an assertion of identity made by a person or a business, for example ‘my name is Peter, I was born on 14 May 1956’. A proof is some form of document that provides evidence for the claim. Proofs come in all sorts of formats. Usually for individuals proofs may comprise photocopies of passports, birth certificates, and utility bills or the original documents. For companies proofs may comprise a bundle of incorporation and ownership structure documents. An attestation is a third party validation that according to their records, the claims are true. For example a University may attest to the fact that someone studied there and earned a degree. An attestation from the right authority is more robust than a proof, which may be forged. However, attestations are a burden on the authority as the information can be sensitive. This means that the information needs to be maintained so that only specific people can access it.

Using SSI, a government can issue a claim to an individual. The individual will store proof of his or her claim and then provide that proof to a third party by sharing the claim. In a digital environment the proof may be stored on a device such as a mobile phone, tablet or computer and the third party can verify the claim by digitally signing it. Through that signature they are verifying that the claim was issued by the government, that the claim has not been tampered with and that the claim was issued to a particular individual. The third party need not refer back to the original issuer of the claim in order to provide the verification.

A printed passport may be regarded as an SSI. The claim is issued by a government and the passport document is proof which is the attested by an immigration officer who inspects the document either manually or electronically to verify that it is genuine.

In the digital environment a problem exists in verifying that a person arriving at immigration is the same person as the person who owns the claims. In the example of a claim stored on a smart device, the device may have been stolen or someone other than the claim holder could have had access to the claims.

The invention aims to address this problem.

### SUMMARY OF THE INVENTION

According to a first aspect of the invention there is provided A method of authorising a bearer of an identity document, comprising the steps of: providing a decentralised identity for the bearer; providing digitally signed biometric data relating to the identity document to the bearer, the biometric data being signed by a trust anchor and validated as being issued to the decentralised identity, the biometric data including an image of the bearer; prior to the bearer travelling, providing the bearer's decentralised identity and biometric data including the image to an authority responsible for admission of the bearer for verification and, on verification, the bearer receiving an authorisation from the authority; on arrival of the bearer, capturing an image of the bearer; matching the image of the bearer with images of a plurality of bearers authorised by the authority; and on successful matching, granting admission to the bearer.

In one embodiment a reduced set of authorised bearers is formed from the plurality of bearers authorised by the authority and matching the image of the bearer with images of the reduced set of authorised bearers.

In one embodiment the step of forming a reduced set of authorised bearers is based on predicted arrival time of each of the plurality of bearers at the point of image capture.

In one embodiment the predicted arrival time of each bearer is calculated from at least one of the arrival time of the bearer at the destination, the walk time from the point of arrival to the point of image capture and the age profile of the bearer.

In one embodiment the arrival time is the time of arrival of an airplane and the predicted arrival time is further calculated from the bearer's seat number on the airplane.

In one embodiment of the invention the step of forming a reduced set of bearers is performed by a machine learning engine and the machine learning engine continuously predicts when individual bearers will arrive at the point of image capture.

The machine learning engine may also manage the size of the reduced set of bearers.

In one embodiment the step of granting admission to the bearer comprises allowing the bearer to pass through an automated border control gate.

In one embodiment the step of providing the bearer's decentralised identity and biometric data including the image to an authority responsible for admission of the bearer for verification, comprises providing the bearer's decentralised identity together with Advanced Passenger Information System (APIS) data.

The authorisation from the authority received by the bearer may be received on a mobile phone of other smart device.

In one embodiment the step of providing the digitally signed biometric data comprises writing the bearer decentralised identity to the blockchain by the trust anchor.

In one embodiment the step of providing the digitally signed biometric data comprises capturing the biometric data and other bearer document data, digitally signing the data using Self Sovereign Identity cryptology and issuing a copy of the digitally signed data to the bearer based on the bearer's decentralised identity. The copy of the digitally signed data may be sent to the bearer's smart device and/or stored at a cloud agent.

In one embodiment the step of providing digitally signed biometric data comprises capturing enhanced biometric data for the bearer and providing the enhanced biometric data with identity document data for signing by the trust anchor. The enhanced biometric data may comprise one or more of multiple images of the bearer, a 3-D image of the bearer, an infrared image of the bearer and an iris scan of the bearer.

In one embodiment the step of capturing enhanced biometric data comprises the bearer providing their decentralised identifier to a kiosk, the kiosk obtaining verification of the decentralised identifier from a location specified in the decentralised identifier, the verification including identity document data including the bearer's image. The kiosk may validate the data received from the specified location as being issued to the bearer's decentralised identifier and not tampered with. The kiosk may validate the bearer by obtaining an image of the bearer and matching the image with the image of the bearer in the verified identity document data.

This aspect invention also provides a system authorising a bearer of an identity document, comprising: an identity provider for providing a decentralised identity for the bearer; means for providing digitally signed biometric data relating to the identity document to the bearer, the biometric data being signed by a trust anchor and validated as being issued to the decentralised identity, the biometric data including an image of the bearer; means for providing, prior to the bearer travelling, the bearer's decentralised identity and biometric data including the image to an authority responsible for admission of the bearer for verification and, on verification, the bearer receiving an authorisation from the authority; an image capture system for capturing an image of the bearer on arrival of the bearer; an image matching system for matching the image of the bearer with images of a plurality of bearers authorised by the authority; and a control gate for granting admission to the bearer on successful matching.

A second aspect of the invention provides a method of authorising a bearer of an identity document to pass through an immigration control, the bearer having a pre-authorisation based on biometric data and a decentralised identity verified by the immigration authority, the method comprising: capturing an image of the bearer; forming a reduced set of authorised bearers from a plurality of bearers authorised by the authority, the reduced set being formed by a machine learning engine, the machine learning engine continuously predicting when individual bearers will arrive at the point of image capture; matching the image of the bearer with images of the reduced set of authorised of bearers authorised by the authority; and on successful matching, granting admission to the bearer. A third aspect of the invention provides a method of pre-authorising a bearer of an identity document for travel, comprising the steps of: providing a decentralised identity for the bearer; providing digitally signed biometric data relating to the identity document to the bearer, the biometric data being signed by a trust anchor and validated as being issued to the decentralised identity, the biometric data including an image of the bearer, the provision of digitally signed biometric data comprising the bearer providing their decentralised identifier to a kiosk, the kiosk obtaining verification of the decentralised identifier from a location specified in the decentralised identifier, the verification including identity document data including the bearer's image; prior to the bearer travelling, providing the bearer's decentralised identity and biometric data including the image to an authority responsible for admission of the bearer for verification and, on verification, the bearer receiving an authorisation from the authority.

### BRIEF DESCRIPTION OF DRAWINGS

Embodiments of the invention will now be described, by way of example only and with reference to the accompanying drawings, in which:

FIG. 1 is a flow chart providing a general overview of an embodiment of the invention and illustrating three separate aspects of the invention;

FIG. 2 illustrates a process for issuing claims;

FIG. 3 illustrates a process for issuing enhanced biometric claims;

FIG. 4 illustrates advance authorisation of passengers; and

FIG. 5 illustrates passenger flow on arrival at an airport.

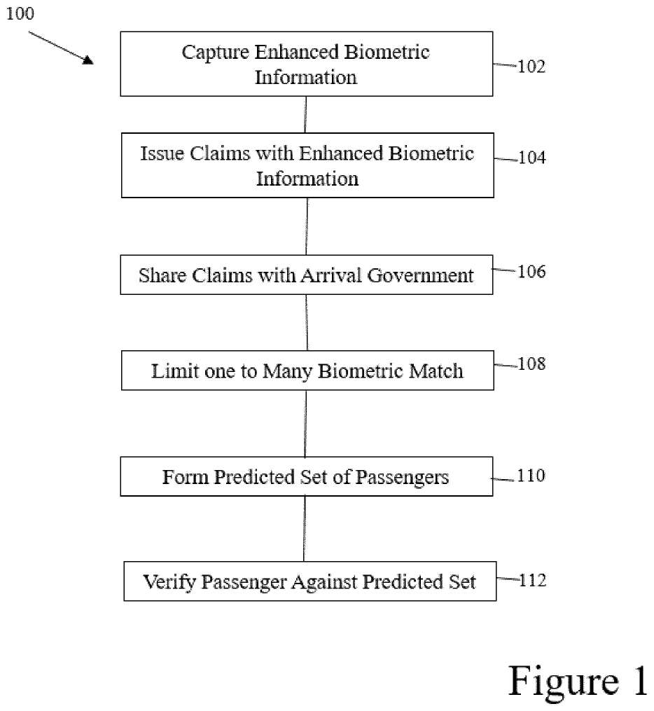

FIG. 1 illustrates the main steps in an embodiment of the invention. This is an exemplary embodiment and not all of the steps are essential to the invention. The method 100 starts at step 102 with the capture of enhanced biometric information as described in more detail below. Claims are then issued by a government agency of other authority with the enhanced biometric information at step 104. Upon arrival of a passenger at an airport, these claims are shared, at step 106, with immigration officials of the government of the arrival country. At step 108, an algorithm is used to limit the one to many biometric match that would be necessary to match an arriving passenger with all possible approved passengers. This results in a predicted set of passengers at 112 which can be used, for example, by an automated border control gate to perform a biometric match against the passenger as they enter the gate. These steps are described in more detail below.

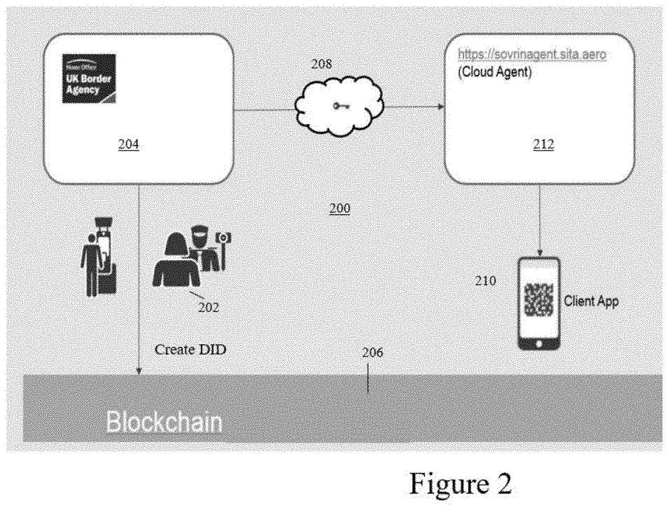

FIG. 2 illustrates steps 102 and 104 of FIG. 1 above in more detail. At present, passport photographs as printed in passports and digitised in biometric passports are of relatively low resolution. They comprise a single photograph of the holder which limits the usefulness of the image for facial matching. In an embodiment of the invention the single passport photo is replaced by one or more of multiple images, a 3 dimensional face capture, one or more infrared images or an iris scan. The multiple images comprise images taken from various angles, for example but not limited to, front-on, left hand side, right hand side, front below and front above.

The images, whether multiple or not, may be of high resolution and each image is digitally signed by the passport issuing authority and issued as a claim to the individual passport holder.

The enhanced quality images may be generated using a dedicated kiosk at an airport. One such suitable kiosk is the applicant's SITA Airport Connect™ kiosk. Such kiosks can read biometric data from passports and may be equipped to capture enhanced biometrics in the form described above. Thus, the kiosks may be provided with a suitable high resolution camera for capturing multiple images and/or a 3D camera and/or an infra-red camera and or iris scanner.

Alternatively, the passenger may present themselves to a government agent for processing or obtain images from a suitable third party source which can then be presented. However the images are obtained, the enhanced biometrics, being the image or images of the type described above, are digitally signed by the government or other issuing authority using known Self Sovereign Identity processes and the claims are issued to the passenger to be stored on their mobile computing device which may be a laptop computer, smart phone, tablet or other suitable device.

FIG. 2 shows this process in more detail where the issuing authority is the UK Border Force, an agency of the United Kingdom government responsible for maintaining the UK's borders. In this process the UK Border force is a Trust Anchor on the network as understood within the context of SSI and is authorised to issue claims and to write data to the network.

In FIG. 2, the process is illustrated generally at 200. At 202, the passenger creates a DID using one of the techniques described above. This DID is presented to the UK Border Force in a convenient form for example as a 2D barcode, QR code or other glyph that the UK Border Force will scan in at 204 and write to the blockchain at 206.

The UK Border Force in this example, or other government or authority, scans the passenger's passport capturing the biometric data that is stored on the passport which may include one or more facial images, iris scans and or other biometric data together with standard ICAO (International Civil Aviation Organisation) passport data such as name, passport data, nationality, expiry date etc. At step 208 this data is digitally signed using known SSI cryptography and a copy of this data is issued to the passenger for storage on their smart device at 210. This step is performed by sending the data to an HTTP REST API identified by the passenger's DID. The data may be sent by other methods, such as secure email, secure file transfer protocol or as a MQ Series Queue and each of these is merely exemplary. In the example of FIG. 2 this is shown at 212 as a cloud agent https://sovrinagent.site.aero. The cloud agent 212 then forwards the data to the passenger's smart device 210 and/or stores a copy in the cloud agent 212.

Thus, the passenger at this stage has a government issued digital copy of their passport details that can be used to assert the passenger's identity. Any other government or suitable authority can request a verification of this data and can verify that the data was issued by a given issuing authority, in this example the UK Border Force, that the data was issued to the passenger as identified by the DID and that the data has not been tampered with.

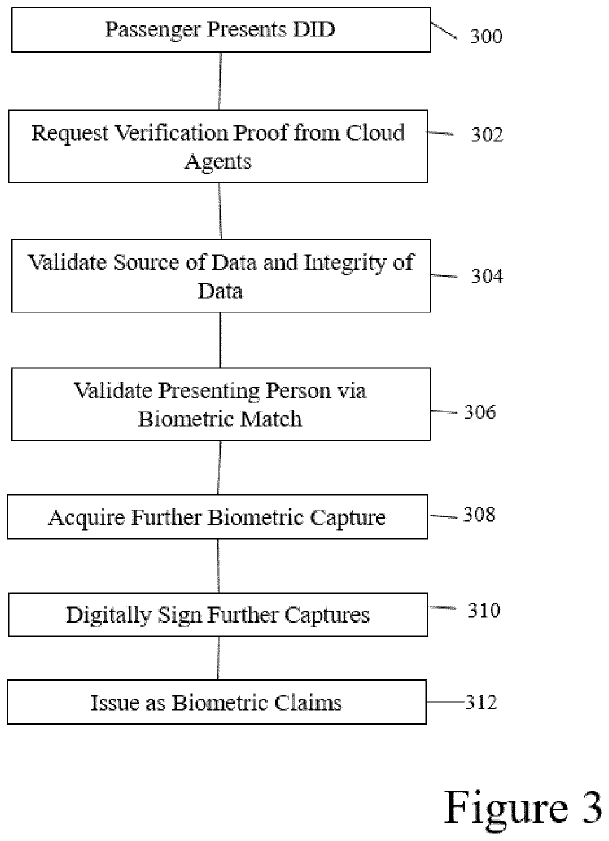

The desirability of obtaining higher resolution biometric data was described above. Having described the DID process, this can now be described in more detail. The following description assumes that the passenger has already obtained a government issued self-sovereign passport identity (the DID). The process is illustrated in the flow diagram of FIG. 3.

At step 300 the passenger approaches a kiosk of the type mentioned above and presents their DID. As also mentioned above this may be done by presenting a barcode for scanning from an app. Other methods are possible, for example transmitting the DID through near field communication or similar communication protocols. At step 302 the kiosk will request a verification proof of the passport data for this DID. The request is issued to the cloud agent 212 (FIG. 2) specified in the DID. The Cloud agent then sends passport data to the kiosk, that data including the passenger's photograph. At step 304 the data is received by the kiosk from the cloud agent and the kiosk then verifies that the data has come from a valid issuing authority, in this example from a valid government issuing authority. It also verifies that the data has been issued to the specific passenger DID and that it has not been tampered with.

At step 306 the kiosk then validates the passenger standing at the kiosk as being the passenger to whom the DID relates. This is done by performing a biometric match, for example by scanning the passenger's face and matching the image acquired with the passport image. This is a one-to-one match and so can be performed quickly.

At step 308 the kiosk then takes further biometric captures. As mentioned above, these could be multiple lower resolution images, multiple higher resolution images, the images being from different angles, 3D images or infrared images. Other types of biometric data could be acquired, for example iris scans.

At 310, the acquired biometric data is digitally signed by the kiosk and at step 312 the signed data is issued as a set of claims for the passenger.

At the end of this process the passenger now has a set of high resolution biometrics associated with their DID and passport data. As described below, these images can later be used at the point of immigration to improve the face match process. However, the acquisition and use of high resolution biometrics as described with respect to FIG. 3 is not essential to the invention.

Referring back to FIG. 1, the description of FIGS. 2 and 3 relates to steps 102 and 104 in FIG. 1. The next step, 106 shares claims with the government at the arrival port. This is, of course in a different country from the government who issues the passport and the DID.

In this description the example given is of an airport. However the embodiments of the invention may be applied to travel between countries by any means of transport including ship, car and rail as the techniques described herein apply not to the mode of transport but to the immigration process.

In the case of air travel, when making a reservation on an airline APIS (Advanced Passenger Information System) data must be provided. APIS data includes passport information, data of birth, address on arrival etc. In an embodiment of the invention, the passenger's decentralised identifier (DID) is shared as part of APIS data. This is a URL endpoint that the arrival government can query to request proof of the passport data claim. The arrival government can verify this data in advance of travel and issue the passenger with authorisation to go through a pre-approved immigration lane, which, as described below, includes a biometric match.

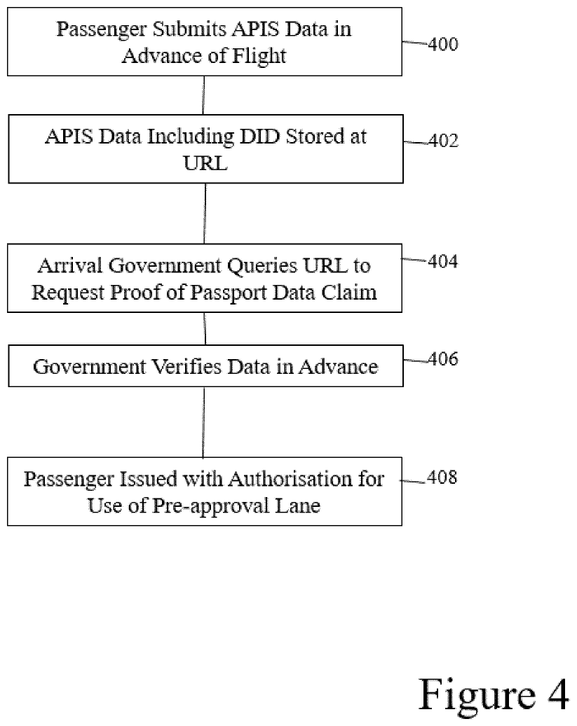

This process is illustrated in FIG. 4. At step 400 the passenger submits APIS information including their DID. This data is stored, at step 402 at a URL which can be accessed by the arrival government. At step 404 the arrival government, which is aware of scheduled incoming flight into its country, queries the URL to request proof of passport data claims. At step 406 the government verifies this data in advance of the flight and at step 408 issues the passenger with authorisation to use a pre-approved lane at immigration. This authorisation may be in any convenient form and may be, for example a barcode that can be scanned at immigration to gain access to the pre-approved lane. This authorisation is another claim back to the passenger proving their right to enter the country.

Referring back to FIG. 1, the final stage involves steps 108-112. The arrival government now has, in effect, a digital copy of the passenger's passport and has verified it is valid. The final step is to perform a face (or other biometric match) against the passenger as they pass though the immigration hall. One option is to scan the image of a passenger using any of the techniques described above, for example, simple low resolution photo, multiple images, high resolution infrared etc. and compare that scan with a database of pre-approved passengers. However such a database could contain millions of images and it is desirable to overcome the problem of a big one-to-many match as this may be slow may be slow or inaccurate. As the immigration procedure has requirements of high security, that is high accuracy, and low queuing times, this is undesirable.

Even if the one-to-many scan were limited to passengers known to be arriving on a given day, the problem is still severe. Taking the example of Atlanta Airport USA (ATL), for the month of July 2017 (see (http://www.atl.com/wp-content/uploads/2017/09/ATL-Traffic-Report-July-2017-pdf) there were almost 600,000 international arrivals. That averages to approximately 20,000 per day. This is too many to do a one-to-many match. We have appreciated that this problem may be addressed by predicting when the passengers will arrive at the immigration point so that the biometric match is only made against the smallest possible number of passengers.

Given the flight actual arrival time, the gate number, the aircraft type, the seat number, the age profile and other similar factors, it is possible to predict when a passenger will arrive at immigration point. Using this prediction, it is possible to restrict the number of passengers a biometric will have to be matched against, and therefore improve the speed, accuracy and reliability of the solution.

As the passenger has now been issued with a claim by the arrival government, the passenger can use an automated border control gate (ABC gate) or similar barrier where a biometric match is performed as the passenger enters the gate. The match will be done by taking a photo of the individual at the gate and matching it against a set of known pre-approved passengers. It is important to limit the size of this set of known passengers. However, in contrast to existing ABC use, the gate remains open and will only close if the biometric match is not positive. This greatly speeds up the journey of the passenger through the immigration area. In another embodiment, the gates will be closed but open as the passenger approaches them. In a further embodiment passenger will walk down a corridor and be monitored by border security staff using remote monitors. As the system recognises a passenger, the image of the passenger is annotated on screen, for example it tags passenger so that border staff only have to stop unrecognised people.

If it is known precisely when the passenger will arrive at immigration, it is possible to reduce the size of this set of IDs to match by including only the passengers who will be at immigration and excluding those passengers who have not yet arrived in the airport or are still walking to immigration. This is a multi-step machine learning process using the following factors to predict when the passenger will arrive:

Actual time of arrival at gate;

Walk time from gate to immigration station;

Seat number;

Age profile of the passenger.

Other factors may be used and this list is merely exemplary. For example, the class of ticket may be used to identify passengers travelling in first or business class as these passengers are likely to disembark the plane first and so arrive earlier at immigration.

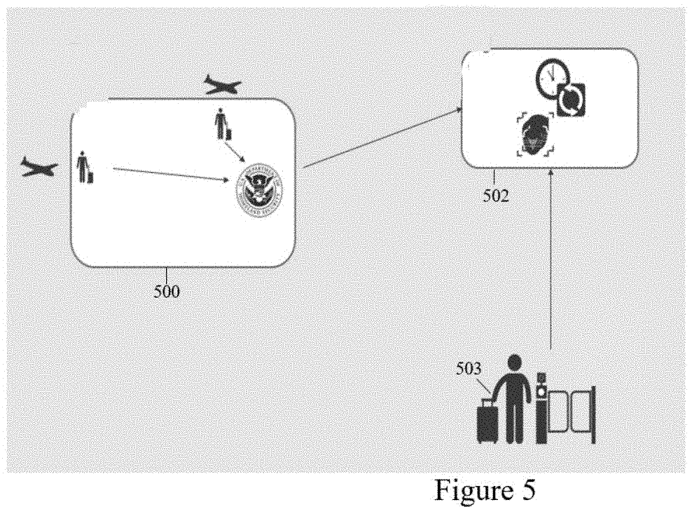

The process on arrival is shown in FIG. 5. At step 500 flights arrive and passengers disembark. The passengers' walk to immigration and data is fed to a Machine Learning engine. At step 502 the ML engine continuously predicts when passengers will arrive at immigration and manages the size of the set of passengers to match against. When passengers arrive at immigration at step 504, they walk to the ABC gate where a biometric will be taken and matched against the predicted set of passengers, so ensuring a rapid match and a minimum of delay for the passenger. The matching process is specific to a given passenger and commences when the passenger steps of the plane, the system being aware that the passenger is on the plane from the pre-departure steps described above.

The process illustrated in FIG. 5 is optional and not essential to the invention. Indeed it may not be needed in airports with low volumes of passengers where not reduction in the match set is required for rapid matching.

The invention has been described with regard to specific embodiments and many variation are possible without departing from the scope of the invention which is defined by the following claims.

1-47. (canceled)

48. A method of authorising a bearer of an identity document, comprising the steps of:
providing a decentralised identity for the bearer;
providing digitally signed biometric data relating to the identity document to the bearer, the biometric data being signed by a trust anchor and validated as being issued to the decentralised identity, the biometric data including an image of the bearer;
prior to the bearer travelling, providing the bearer's decentralised identity and biometric data including the image to an authority responsible for admission of the bearer for verification and, on verification, the bearer receiving an authorisation from the authority;
on arrival of the bearer, capturing an image of the bearer;
forming a reduced set of authorised bearers from the plurality of bearers authorised by the authority;
matching the image of the bearer with images of the reduced set of bearers authorised by the authority; and
on successful matching, granting admission to the bearer.

49. The method according to claim 48, wherein the step of forming a reduced set of authorised bearers is based on predicted arrival time of each of the plurality of bearers at the point of image capture.

50. The method according to claim 49, wherein the predicted arrival time of each bearer is calculated from at least one of the arrival time of the bearer at the destination, the walk time from the point of arrival to the point of image capture and the age profile of the bearer.

51. The method according to claim 50, wherein the arrival time is the time of arrival of an airplane and the predicted arrival time is further calculated from the bearer's seat number on the airplane.

52. The method according to claim 48, wherein the step of granting admission to the bearer comprises allowing the bearer to pass through an automated border control gate.

53. The method according to claim 48, wherein the step of providing the bearer's decentralised identity and biometric data including the image to an authority responsible for admission of the bearer for verification, comprises providing the bearer's decentralised identity together with Advanced Passenger Information System (APIS) data.

54. The method according to claim 48, wherein the step of providing the digitally signed biometric data comprises writing the bearer decentralised identity to the blockchain by the trust anchor.

55. The method according to claim 54, wherein the step of providing the digitally signed biometric data comprises capturing the biometric data and other bearer document data, digitally signing the data using Self Sovereign Identity cryptology and issuing a copy of the digitally signed data to the bearer based on the bearer's decentralised identity.

56. The method according to claim 55, wherein the copy of the digitally signed data is sent to the bearer's smart device and/or stored at a cloud agent.

57. The method according to claim 56, wherein the step of capturing enhanced biometric data comprises the bearer providing their decentralised identifier to a kiosk, the kiosk obtaining verification of the decentralised identifier from a location specified in the decentralised identifier, the verification including identity document data including the bearer's image.

58. The method according to claim 57, wherein the step of capturing enhanced biometric data further comprises the kiosk validating the data received from the specified location as being issued to the bearer's decentralised identifier and not tampered with.

59. The method according to claim 58, further comprising the kiosk validating the bearer by obtaining an image of the bearer and matching the image with the image of the bearer in the verified identity document data.

60. The method according to claim 59, wherein the step of capturing enhanced biometric data comprises capturing and digitally signing one or more of multiple images of the bearer, a 3-D image of the bearer, an infrared image of the bearer and an iris scan of the bearer, and issuing the enhanced biometric data as a biometric claim.

61. A system authorising a bearer of an identity document, comprising:
an identity provider for providing a decentralised identity for the bearer;
means for providing digitally signed biometric data relating to the identity document to the bearer, the biometric data being signed by a trust anchor and validated as being issued to the decentralised identity, the biometric data including an image of the bearer;
means for providing, prior to the bearer travelling, the bearer's decentralised identity and biometric data including the image to an authority responsible for admission of the bearer for verification and, on verification, the bearer receiving an authorisation from the authority;
an image capture system for capturing an image of the bearer on arrival of the bearer;
an image matching system for matching the image of the bearer with images of a plurality of bearers authorised by the authority, the image matching system configured to form a reduced set of authorised bearers from the plurality of bearers authorised by the authority and to match the image of the bearer with images of the reduced set of authorised bearers; and
a control gate for granting admission to the bearer on successful matching.

62. The system according to claim 61, wherein the image matching system is configured to form a reduced set of authorised bearers based on predicted arrival time of each of the plurality of bearers at the point of image capture.

63. The system according to claim 62, wherein image matching system is configured to calculate the predicted arrival time of each bearer from at least one of the arrival time of the bearer at the destination, the walk time from the point of arrival to the point of image capture and the age profile of the bearer.

64. The system according to claim 61, wherein the image matching system comprises a machine learning engine to form the reduced set of bearers and the machine learning engine is configured to continuously predict when individual bearers will arrive at the point of image capture.

65. A method of authorising a bearer of an identity document to pass through an immigration control, the bearer having a pre-authorisation based on biometric data and a decentralised identity verified by the immigration authority, the method comprising:
capturing an image of the bearer;
forming a reduced set of authorised bearers from a plurality of bearers authorised by the authority, the reduced set being formed by a machine learning engine, the machine learning engine continuously predicting when individual bearers will arrive at the point of image capture;
matching the image of the bearer with images of the reduced set of authorised of bearers authorised by the authority; and
on successful matching, granting admission to the bearer.

66. The method according to claim 65, wherein the predicted arrival time of each bearer is calculated from at least one of the arrival time of the bearer at the destination, the walk time from the point of arrival to the point of image capture and the age profile of the bearer.

67. A method of pre-authorising a bearer of an identity document for travel, comprising the steps of:
providing a decentralised identity for the bearer;
providing digitally signed biometric data relating to the identity document to the bearer, the biometric data being signed by a trust anchor and validated as being issued to the decentralised identity, the biometric data including an image of the bearer, the provision of digitally signed biometric data comprising the bearer providing their decentralised identifier to a kiosk, the kiosk obtaining verification of the decentralised identifier from a location specified in the decentralised identifier, the verification including identity document data including the bearer's image;
prior to the bearer travelling, providing the bearer's decentralised identity and biometric data including the image to an authority responsible for admission of the bearer for verification and, on verification, the bearer receiving an authorisation from the authority.
